(19) United States
(12) Patent Application Publication
(10) Pub. No.: US 2003/0116094 A1
(43) Pub. Date: Jun. 26, 2003

(54) Pet travel dish

(76) Inventor: Kenneth A. Dlin, Denver, CO (US)

Correspondence Address: THOMAS W. HANSON, LLC, 3990 S. CHEROKEE ST., ENGLEWOOD, CO, 80110, US

(21) Appl. No.: 10/032,120

(22) Filed: Dec. 21, 2001

(51) Int. Cl. A01K 1/10; A01K 5/00; A01K 39/00

(52) U.S. Cl. 119/61

(57) ABSTRACT

A pet dish adapted for use in a car or other vehicle. The dish has a lower section designed to fit into a cup holder; an enlarged upper section; and an asymmetric overhanging section which extends well beyond the outer diameter of the upper and lower sections. Preferably all three sections form a single continuous container. Alternatively, the lower section may be partitioned and may contain either a permanent or removable counterweight. The dish may be fitted with an optional mounting strap or hook so that it may be suspended from a window, door, or other structure. One side of the dish may be flattened to reduce rotational movement about the mounting strap or to improve clearance.

### BACKGROUND OF THE INVENTION

1. Field of the invention

The present invention relates to the field of pet dishes and specifically to pet dishes intended for use in a vehicle.

2. Background Information

Significant numbers of people travel with their pets in automobiles or other vehicles. This travel may be an extended vacation or short trips around town. In either case, the pet needs to be supplied with water and possibly food. Water can be critical even on short trips in hot weather, especially if the pet remains in the vehicle when it is parked. On longer trips, supplying both food and water may make the experience more enjoyable for the pet and thus for the owner.

Probably the most common way of providing food and water is to periodically stop, let the pet out of the vehicle, and place dishes on the ground. While this approach works, the stops may not be frequent enough and it may be hazardous to the pet if the owner merely stops at the side of the road, rather than at a rest stop.

Alternatively, dishes may be provided within the vehicle, either while moving or when stopped. Many types of dishes have been developed to assist with this task. Many focus on being spill resistant while others focus on being collapsible. Almost all depend on there being a flat surface on which the dish can be placed and which the pet can access. A station wagon, or pickup truck may have sufficient space available for access by any pet, assuming the space hasn't been packed full of luggage. A conventional car typically only provides the seats and the foot wells between the seats. Airplanes, boats, and other vehicles are similarly arranged. While this may suffice for small animals, which can easily fit into the foot wells, it is inadequate for larger animals which can not do so. Placing the dishes on the seat is risky because most seats are slanted, and many curved, raising the likelihood of spilling.

There is a need for a pet dish which can be used both while the vehicle is stationary and while it is in motion. The dish should be easily accessible by a pet, especially a large one, while the pet is positioned on one of the seats. Preferably the dish could be positioned approximately at seat height and be held in position, resistant to movement or spilling. The dish should be usable for either food or water. The dish should be also easily installed in and removed from the vehicle and require no modification of the vehicle.

### BRIEF SUMMARY OF THE INVENTION

The present invention is directed to a pet dish designed to fit into and be retained by a standard cup holder while having a sufficiently large opening to provide easy access by the pet.

According to the invention there is provided a body section adapted to fit into a cup holder and an overhanging section extending outward from the body section. The body section may be divided into a lower section which fits the cup holder and an enlarged upper section which further increases the volume and opening size of the dish.

According to an aspect of the invention the overhanging section has an arcuate cross-section, or more technically a sector of either a cylinder or an inverted frustum. Where the lower section and/or the upper section are also arcuate the overhanging section may be concentric with one or both of the other sections.

According to another aspect of the invention the dish may have a removable strap or hook to suspend or mount the dish, as from a car door. This strap or hook may engage a fitting formed in the side of the dish.

Further in accordance with the invention one side of the dish may be flattened, or planar, to stabilize the dish when suspended or to improve clearance when placed in a cup holder.

Still further in accordance with the invention, the dish may be fitted with a removable rim to reduce the risk of spilling or splashing of the contents.

Yet still further in accordance with the invention, the dish may use a permanent, or removable, counterweight, preferably contained in the lower section of the dish, which is then partitioned from the upper and overhanging sections.

The advantages of such an apparatus are that a pet dish may be secured within a vehicle in a position accessible by a pet occupying a seat. The dish will resist spilling or tipping because it is stabilized by the cup holder. This provides a method of securely mounting the dish within the vehicle without modifying or attaching anything to the vehicle itself.

The above and other features and advantages of the present invention will become more clear from the detailed description of a specific illustrative embodiment thereof, presented below in conjunction with the accompanying drawings.

### BRIEF DESCRIPTION OF THE SEVERAL VIEWS OF THE DRAWINGS

FIG. 1 is an isometric view of the preferred embodiment.

FIG. 2 is side view of the preferred embodiment.

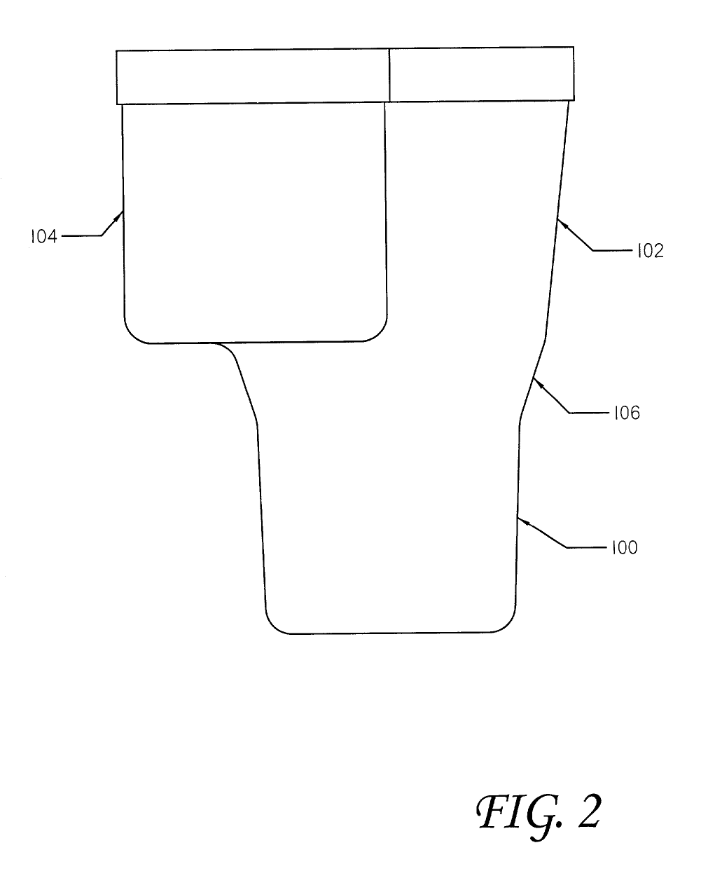

FIG. 3 is an exploded view of the preferred embodiment fitted with an optional splash resistant rim.

FIG. 4 is a cross section through the dish and rim of FIG. 3 in a plane through the center of the dish, parallel to the front view.

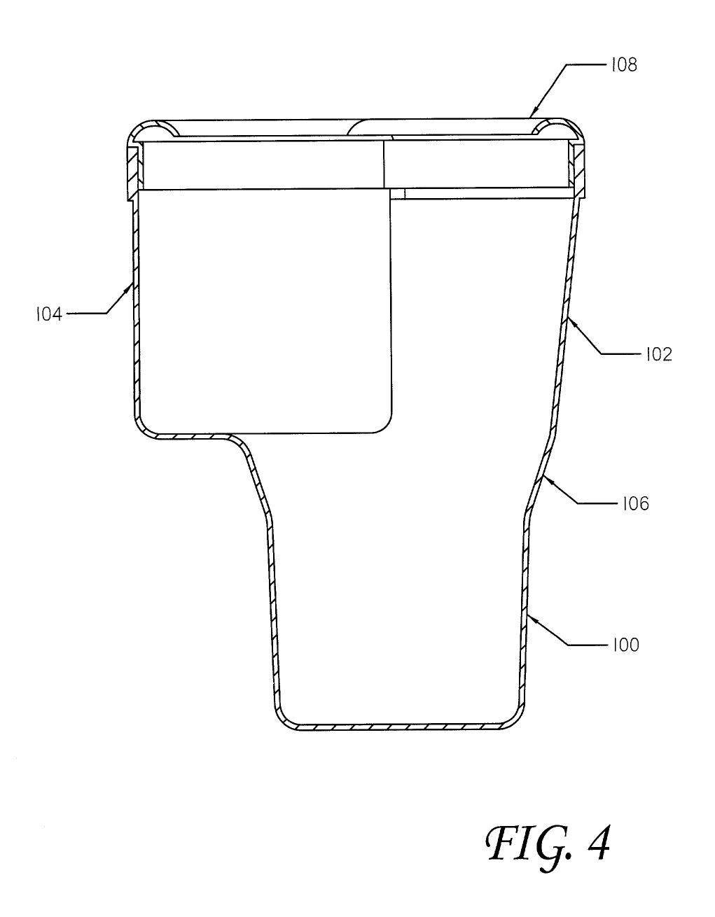

FIG. 5 is a cross section through an alternative embodiment having separate upper and lower sections, in the same plane as FIG. 4.

FIG. 6 illustrates an alternative embodiment having a smaller overhanging section.

FIG. 7 illustrates an alternative embodiment having a larger overhanging section and a flattened side.

FIG. 8 illustrates the embodiment of FIG. 7 further fitted with a strap or hanger.

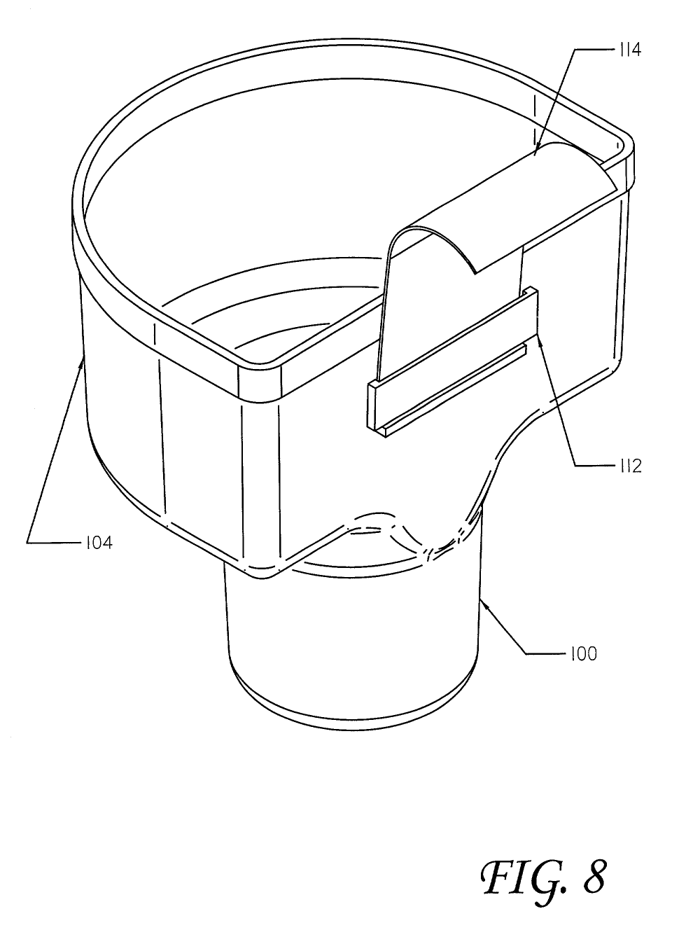

FIG. 9 illustrates the embodiment of FIG. 7 further fitted with an encircling hanger.

### DETAILED DESCRIPTION OF THE INVENTION

The following discussion focuses on the preferred embodiment of the inventive pet dish, having a reduced diameter lower section and an overhanging upper section which is roughly semi-circular. However, as will be recognized by those skilled in the art, the disclosed apparatus is adaptable to a variety of embodiments differing in dimension or span but still consistent with the spirit of the invention. While intended for use as a pet dish, other containment or storage applications are anticipated.

Glossary

The following is a brief glossary of terms used herein. The supplied definitions are applicable throughout this specification and the claims unless the term is clearly used in another manner.

Body section—the combination of lower section and upper section where they are formed as a single continuous section such as a cylinder or inverted frustum.

Cup holder—also commonly referred to as a drink holder, this term is intended to be broadly interpreted and encompasses any device which serves to hold or stabilize a glass, cup, or other beverage container. While the expected use of the invention is with cup holders installed in vehicles, its use with similar cup holders in other environments is also anticipated. As an example, cup holders could be affixed to a wall inside or outside of a house, kennel, or other structure and used to hold dishes according to the present invention at a convenient height for one or more animals.

Cylindrical/Conical—it is well known in the field of injection molding that parts must typically be formed with a slight draft angle to ease extraction from the mold. As such a cylindrical shape would actually have a slight taper, thus being technically frusto-conical. Herein, cylindrical is intended to encompass such frusto-conical shapes having tapers on the order of 2 degrees or less.

Overhanging section—that section, on generally the same level as the upper section, which has a substantially greater diameter than either of the other sections.

Lower section—that reduced diameter section intended to be placed within the cup holder.

Sector—as applied herein to a sector of a cylinder or of a conical frustum, it is a section taken vertically through one of these two shapes based on a region bounded by two radii of the shape's base disk.

Upper section—that section, above the lower section, which is typically somewhat larger in diameter and preferably tapers outward.

Preferred Embodiment

The disclosed invention is described below with reference to the accompanying figures in which like reference numbers designate like parts. Generally, numbers in the 200's refer to prior art elements or elements in the surrounding environment while numbers in the 100's refer to elements of the invention.

Overview

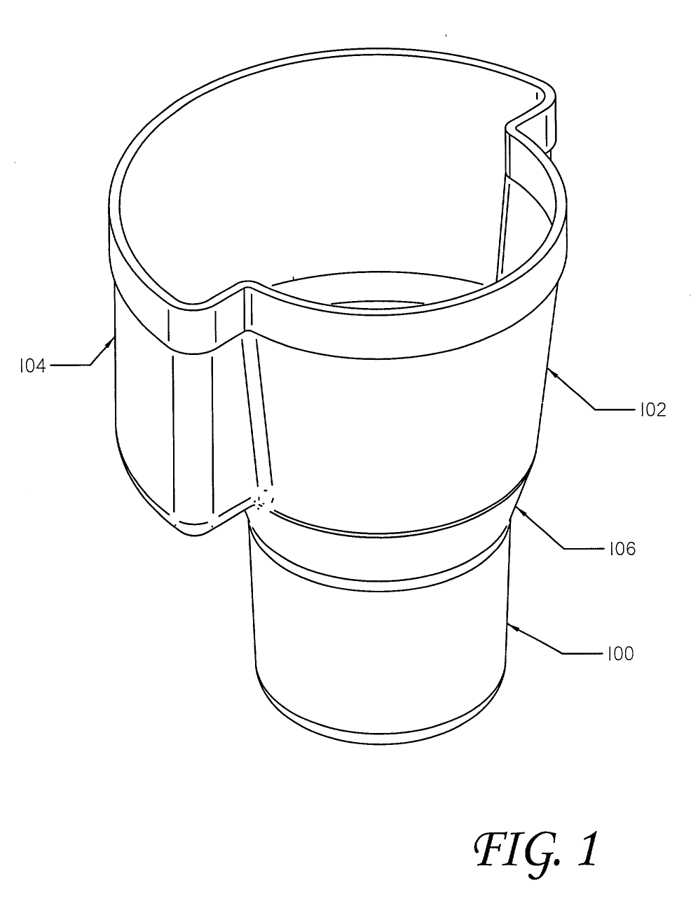

Referring to FIGS. 1 & 2, the preferred embodiment of the invention can be seen. It can be considered to have three general sections. The lower section, 100, is adapted to fit into automotive cup holders as are typically installed in or available for vehicles. The upper section, 102, has a somewhat larger diameter which preferably flares outward.

The overhanging section, 104, is unique to the inventive pet dish. It significantly enlarges the opening of the dish, increases capacity, and extends the opening away from the console, dashboard, or other surface to which the cup holder is attached. This offset makes it much easier for the pet to reach the contents of the pet dish without interference from any adjacent structure.

Structure

The lower section, 100, has the primary purpose of removably securing the pet dish in a cup holder. As such, its shape and size closely mimics that of conventional drink cups, or glasses. General consumer satisfaction effectively dictates that the cup holders and drink cups be matched to each other without significant variation. This fact allows the inventive pet dish to be designed to match the lower portion of a drink cup, assuring that it will fit a wide range of available cup holders. In the preferred embodiment, the lower section has a diameter of approximately 2.5 inches and a height of approximately 2 inches. A slight draft, or taper, narrower at the bottom, is preferred to enable stacking of the dishes for storage or display and for mold release purposes where the dish is manufactured by injection molding. However neither the exact dimensions nor the taper is essential to the functioning of the dish. It is also not required that the lower section be circular in cross section. Other shapes, such as triangular or square would also work, as long as they fit within a cup holder. In the preferred embodiment, the lower section is open to the upper section. As discussed below, it may alternatively be closed off.

The increased diameter upper section, 102, serves to increase the capacity of the dish and to and ease access by the pet. As with the lower section, the profile of the upper section mimics that of widely available drink cups, generally a sector of a cylinder or conical frustum, semi-circular in the preferred embodiment. While is there is greater variation in the diameter of the upper portion of such drink cups, they provide a guideline for compatibility. Here the main concern is that the upper section not be of such large diameter that it interferes with whatever structure mounts or is adjacent to the cup holder. While the upper section is preferably concentric with the lower section, that is not required. Alternatively, the upper section need not have an increased diameter. Rather, the upper section could be a smooth continuation of the lower section at a constant diameter (i.e. cylindrical), or continuous taper (i.e. inverted frusto-conical). conical). In this case the combined lower and upper sections may more appropriately be referred to as a single body section.

The tapered section, 106, joining the lower section to the upper section, and to the overhanging section, has both aesthetic and functional purposes. Aesthetically, a smooth transition is more pleasing, but many shapes would achieve that purpose. Functionally, the taper improves the fit of the pet dish to the cup holder. Where the taper rests in the upper surface of the cup holder, it helps center the pet dish within the holder, making it more stable. It's rapidly increasing diameter adapts the dish to a wider range of cup holder sizes.

The overhanging section, 104, is important to the functionality of the pet dish. This section has a substantially larger diameter and extends outward well beyond the lower section. Primarily this makes it easier for the pet to access the contents of the dish by extending the opening away from the supporting or adjacent structure and by increasing the size of the opening in the dish. Secondarily, the increased diameter also increases the capacity of the dish. Preferably the overhanging section is asymmetric for clearance purposes. As with the upper section, the overhanging section is preferably a sector of a cylinder or inverted conical frustum. If desired, such as for use with a center console cup holder with no interference, the overhanging section could extend a full 360 degrees. In the preferred embodiment, the sweep of the overhanging section is approximately 180 degrees. This dimension is not critical and, as discussed below, alternative embodiments utilize other amounts of sweep. In the preferred embodiment, the overhanging section is formed as a single arc, concentric with the upper and lower sections. While desirable, this is not critical. It could clearly be offset from the other sections and need not be arcuate. Other shapes, such as triangular or ellipsoid would offer the advantage of greater reach outward from the cup holder with a lesser increase in weight.

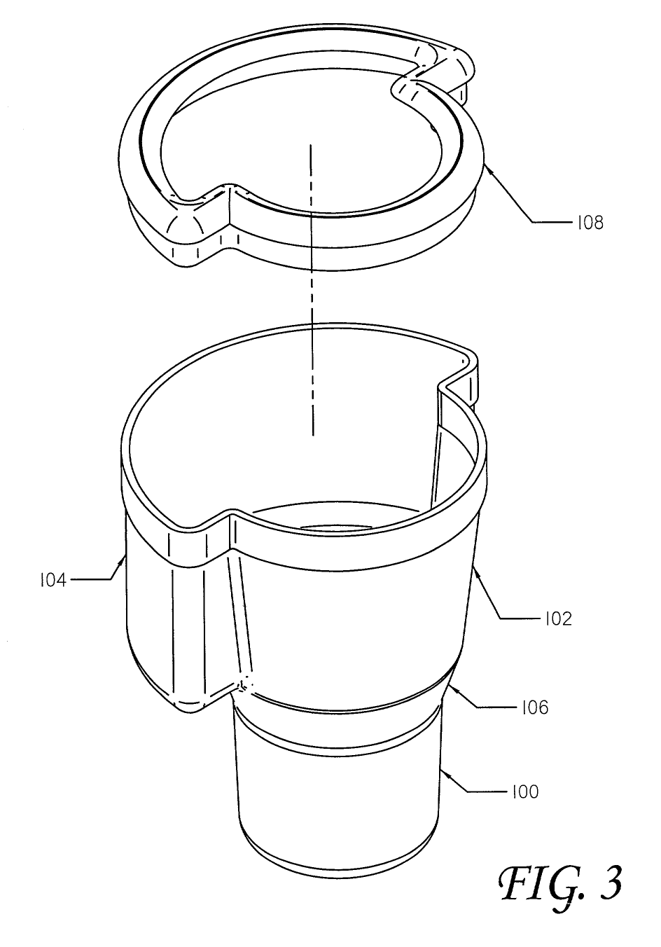

FIGS. 3 & 4 illustrate the optional rim or lip which can be fitted to the dish. While it could be formed integrally, it is preferably removable. Ideally, the rim fits within the upper edge of the upper and overhanging sections and curves inward. Its primary purpose is to reduce the likelihood of water spilling or splashing over the edge of the dish, especially while the vehicle is in motion. It is preferably removable so that when the dish is used with contents not susceptible to spilling, such as dry food, the rim can be removed to provide greater access. A removable rim also simplifies cleaning the dish.

Materials

It is anticipated that the inventive dish would typically be manufactured by injection molding plastic. However, the design also lends itself to metals, such as stainless steel which would provide a more durable product. The choice of material and manufacturing process is not critical to the invention.

Alternative Embodiments

The following discussion presents alternative embodiments which offer various advantages in structure or function without departing from the principles of the invention.

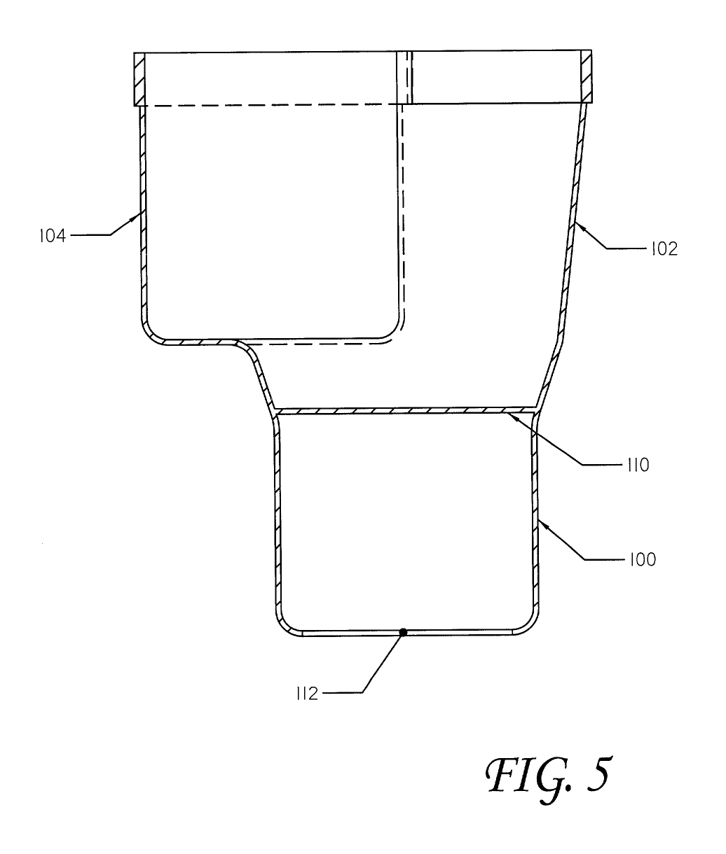

In the alternative embodiment of FIG. 5, the lower section, 100, has been closed off from the upper and overhanging sections by floor, 110. Preferably, the lower section would then have an opening, 112, at the bottom. This arrangement provides a floor on the dish at the bottom of the upper section, or alternatively even with the bottom of the overhanging section. This eliminates the smaller diameter lower section from the volume of the dish which actually holds the contents. Such a narrower section may be unreachable by the pet, whose muzzle may be larger than the lower section. Where the only remaining food or water is located within this smaller section, the pet may struggle or paw at the dish to reach the remaining contents. This, in turn, may result in the dish being tipped or overturned. As a further alternative, the now separate lower section may be filled with a counter weighting material to stabilize the dish. This may be loose, such as sand or lead shot; cast in place, such as a resin compound; or even liquid, such as water. Loose or liquid materials would, of course, require that the bottom opening be eliminated. If desired, the resulting compartment could be fitted with a removable plug, or other fitting, to allow the material to be added, removed, or adjusted, at the user's convenience. The compartment could also store additional food or water which can be kept segregated and transferred to the dish portion when needed.

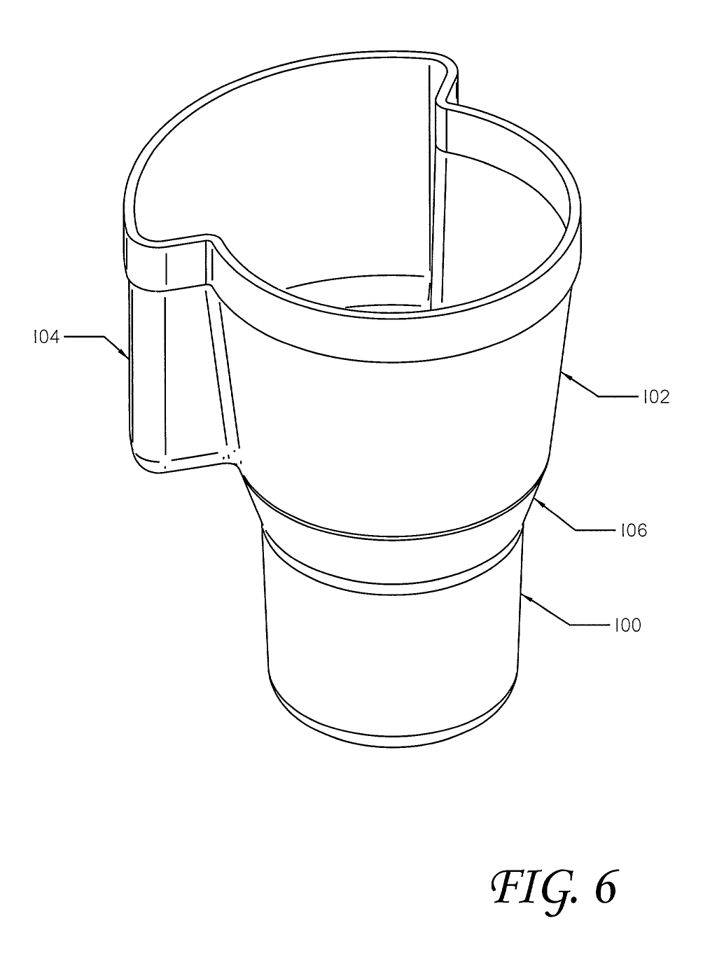

FIG. 6 illustrates an alternative embodiment in which the sweep of the overhanging section, 104, has been reduced. Such a configuration would allow two dishes to be placed in immediately adjacent cup holders, providing both food and water, for example, in one location. Clearly a range of spans could be used to adapt the dish to a variety of situations.

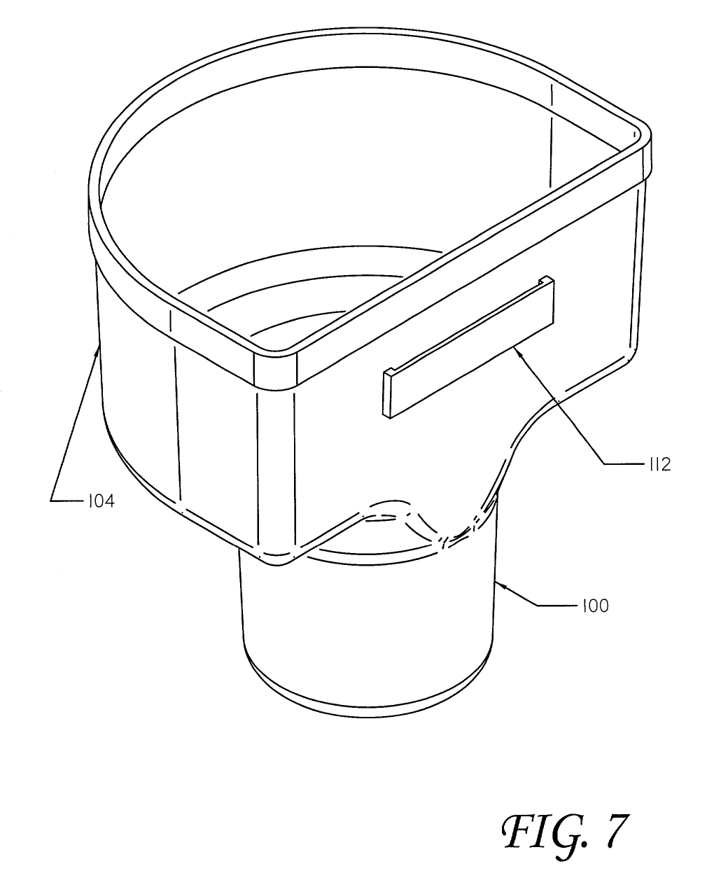

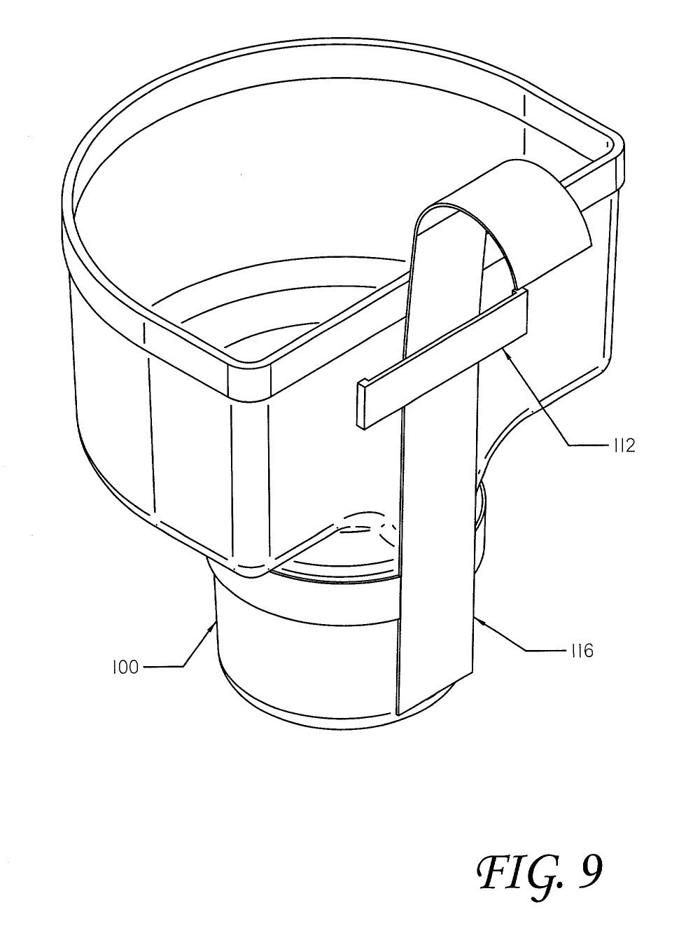

FIGS. 7 & 8 illustrate an alternative embodiment in which one side of the upper section has been flattened and the overhanging section extended to meet the flat side. Additionally a fitting, 112, has been provided for the connection of a strap, hook, or similar mounting device, 114. The mounting device would connect to a car door, window, or arm rest, suspending the dish adjacent the door panel. The flat portion of the dish would then bear against the door panel stabilizing the dish and preventing it from rocking side to side. The flat portion may also improve clearance with some cup holders and may be used without the fitting or mounting device. The above suspension techniques are used with cup holders and any such method would be applicable. Alternatively, the mounting device, 116 in FIG. 9, could grasp or encircle the dish at some point, such as just below the overhanging section. Such a mounting device could be used with or without the above fitting.

While the preferred form of the invention has been disclosed above, alternative methods of practicing the invention are readily apparent to the skilled practitioner. The above description of the preferred embodiment is intended to be illustrative only and not to limit the scope of the invention.

I/We claim:

1. A pet dish comprising:
(a) a body section adapted to be received by a cup holder;
(b) an overhanging section immediately adjacent and communicating with said upper section;
said body and overhanging sections having a shared continuous upward opening.

2. The pet dish of claim 1 wherein said overhanging section has an outer periphery, at least a portion of which is arcuate.

3. The pet dish of claim 2 wherein at least a portion of said lower section is substantially cylindrical and is concentric with said arcuate periphery portion of said overhanging section.

4. The pet dish of claim 2 wherein said outer periphery of said overhanging section further comprises a planar portion opposite said arcuate portion.

5. The pet dish of claim 1 further comprising mounting device adapted to suspend said pet dish.

6. The pet dish of claim 5 wherein said mounting device is removably attached.

7. The pet dish of claim 6 wherein said dish further comprises an integral fitting and wherein said mounting device engages said fitting.

8. The pet dish of claim 1 further comprising a removably attached, inwardly extending rim fitted to said opening.

9. A pet dish comprising:
(a) a lower section adapted to be received by a cup holder;
(b) an enlarged upper section above and attached to said lower section; and
(c) overhanging section immediately adjacent and communicating with said upper section said upper and overhanging sections having a shared continuous upward opening.

10. The pet dish of claim 9 wherein each of said upper and lower sections is a sector of a shape chosen from the group consisting of cylinder or inverted conical frustum and wherein said upper section is concentric with said lower section

11. The pet dish of claim 10 wherein said overhanging section is a sector of a shape chosen from the group consisting of cylinder or inverted conical frustum and wherein said overhanging section is concentric with both said upper section and said lower section.

12. The pet dish of claim 9 wherein said lower section is partitioned from said upper section.

13. The pet dish of claim 12 further comprising counterweight material contained within said lower section.

14. The pet dish of claim 12 wherein said lower section is adapted to receive removable counterweight material.

15. The pet dish of claim 9 further comprising a tapered section joining said lower section to said upper section.

16. A pet dish comprising:
(a) a lower section adapted to be received by a cup holder;
(b) an enlarged upper section above and attached to said lower section;
(c) overhanging section immediately adjacent and communicating with said upper section; and
(d) a removably attached mounting device adapted to at least partially encircle said lower section.

17. The pet dish of claim 16 wherein said dish further comprises an integral fitting and wherein said mounting device engages said fitting.
